(19) United States
(12) Patent Application Publication
(10) Pub. No.: US 2005/0087380 A1
(43) Pub. Date: Apr. 28, 2005

(54) Variator in a four wheel drive

(76) Inventor: Todd Brown, Bata Via, OH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/693,528

(22) Filed: Oct. 24, 2003

(51) Int. Cl. B60K 17/34

(52) U.S. Cl. 180/233

(57) ABSTRACT

A power transmission system and drive train for a vehicle and more particularly an all-wheel-drive (AWD) power transmission system which directly transmits drive power to both a first and second set of drive wheels of the vehicle via a continuously variable coupling accommodating the speed difference between the first and second set of drive wheels and also relating to an alternative power take off path from a transmission PTU side shaft to power the rear drive train.

### FIELD OF THE INVENTION

The present invention relates to the field of power transmission systems for a vehicle and more particularly a power transmission system which directly transmits drive power to both a first and second set of drive wheels of the vehicle via a continuously variable coupling accommodating the speed difference between the first and second set of drive wheels and also relating to an alternative power take off path from a transmission PTU side shaft to power the rear drive train.

### BACKGROUND OF THE INVENTION

There are both part-time four wheel drive systems and full-time, or all-wheel drive systems (AWD) known in the industry. The main parts of any four wheel drive system are the front and rear differentials, and the transfer case.

The front differential is located between the two front wheels and the rear differential positioned between the rear wheels. The differentials send torque from the drive shaft of the transmission to the drive wheels and allow the left and right wheels to spin at different speeds when the vehicle traverses a turn. As is well known, when a vehicle turns, the inside wheels generally follow a different (shorter) path from the outside wheels which have a longer path and therefore must rotate faster to keep pace with the inside wheels.

Additionally, because generally the front wheels steer the vehicle, the front wheels follow a different path than the rear wheels, not a problem in front or rear wheel drive only situations, however in a four wheel, or all-wheel drive situation where the front and rear wheels are both driven, the drive line must account somewhere for the fact that each of the front and rear wheels may spin at a different speed.

An all-wheel drive system contains a device that allows for a speed difference between the front and rear wheels. As is well known in the art, this could be a viscus coupling, center differential, open differential, a dog clutch, an uncontrolled clutch, a controlled clutch, a clutch within an integrated pump or even a Torsen locking differential. Such devices allow an all-wheel drive system to function on whatever surface the vehicle is traveling upon.

In addition, important components of part-time systems include locking hubs and both types of systems may include advanced electronics for control and braking systems that intend to make even better use of all available traction. A part-time four wheel drive system connects the front axle drive shafts through the rear axle drive shafts on demand, so that the wheels are forced to spin at the same speed. As is well known in the art, and as described above with respect to the wheels spinning at different speeds, this also requires the tires slip when the car goes around a turn, thus on a dry surface, for instance, dry pavement, it is not easy for the tires to slip so the four wheel drive transmission should be disengaged in order to avoid jerky turns and extra wear on the tires and drive train.

### SUMMARY OF THE INVENTION

Wherefore, it is an object of the present invention to incorporate in an all-wheel drive system continuously variable coupling, CVC, to account for differences in speed between the rear wheel drive axles and the front wheel drive axles.

Another object of the present invention is to utilize a belt or chain variator as the continuously variable coupling device.

A further object of the present invention is to also use other continuously variable devices such as a toroidal drive and ratio disc as known in the art.

Yet another object of the present invention is to provide a full-time lockup between the front and rear wheel drives while being able to continuously vary the speed between the axles.

A still further object of the present invention is the full provision of an all-wheel drive system that locks the front and rear wheels in both slippery and dry conditions and does not waste any power between slipping clutches or tires.

A further object of the present invention is that the CVC can be electronically or mechanically operated. An electronically operated CVC can use wheel speed sensors, steering wheel angle or other known sensors to determine the variator ratio. A mechanically operated CVC might use a cam device to send torque increases of various ratios.

Yet still further object of the present invention is to provide a ratio span or range of around 1.5 as the speed difference between the front and rear axles to permit use of a small variator.

A further object of the present invention is to vary torque into and out of the CVC by utilizing planetary or helical gear sets to reduce/increase the torque into and out of the variator, if necessary.

Another object of the invention is to provide a direct power take off for the rear wheel drive shaft from the side shaft, or intermediate shaft of the transmission.

A still further object of the invention is to provided the side shaft of the transmission being driven by a variator of a continuously variable transmission.

The present invention also relates to a four wheel drive vehicle comprising a prime mover powering a transmission providing drive power to a front drive train and rear drive train; the front drive train having a front transaxle driveably connected to the transmission, the front transaxle having a first differential device located between at least a first and a second front wheels; the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels; and a continuously variable coupling situated in the drive train to provide contiguous power transmission between the front drive train and the rear drive train at a desired ratio permitting a difference between a front wheel rotation speed and a rear wheel rotation speed.

The present invention also relates to a four wheel drive vehicle comprising a prime mover powering a continuously variable transmission providing drive power to a front drive train and rear drive train; the front drive train having a front transaxle driveably connected to the transmission, the front transaxle having a first differential device located between at least a first and a second front wheels; the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels; and a side shaft separate from the front drive train extending from the continuously variable transmission to provide a power take off for the rear drive shaft independent of any torque change through the front drive train.

The present invention also relates to a drive train for a four wheel drive vehicle comprising a prime mover powering a continuously variable transmission providing drive power to a front drive train and rear drive train; the front drive train having a front transaxle driveably connected to the transmission, the front transaxle having a first differential device located between at least a first and a second front wheels; the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels; a side shaft separate from the front drive train extending from the continuously variable transmission to provide a power take off for the rear drive shaft independent of any torque change through the front drive train; and a continuously variable coupling situated in the drive train to provide contiguous power transmission between the front drive train and the rear drive train at a desired ratio permitting a difference between a front wheel rotation speed and a rear wheel rotation speed.

### BRIEF DESCRIPTION OF THE DRAWINGS

The invention will now be described, by way of example, with reference to the accompanying drawings in which:

FIG. 1 is a vehicle chassis and drive train as is known in the art;

FIG. 2 is a diagrammatic drive train of an all-wheel drive vehicle having a CVC coupling device in the drive line;

FIG. 3 is a cross-section of the CVC coupling device with a mechanical ramp and bearing ratio varying device;

FIG. 4 is a diagrammatic view of the side shaft of a transmission directly driving the rear drive shaft of an all-wheel drive system;

FIG. 5 is a cross-sectional view of a CVT variator having a side shaft directly driven by one of the pulley shafts in the variator; and

FIG. 6 is cross sectional view of a power takeoff unit (PTU) off of the transmission side shaft.

### DETAILED DESCRIPTION OF THE INVENTION

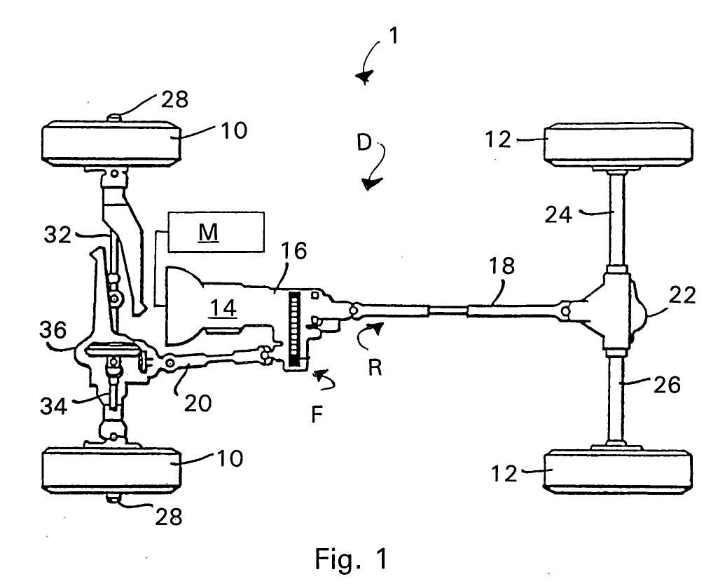

Referring to FIG. 1, a vehicle 1 with which the device of the present invention can be used, includes a front set of wheels 10 and a rear set of wheels 12, an automatic, manual or CVT transmission 14 for producing multiple forward and reverse speed ratios driven by an engine or prime mover M, and a transfer case 16 for continuously driveably connecting the transmission output to a rear drive shaft 18 and for connecting the transmission output to a front drive shaft 20. Rear drive shaft 18 transmits power to a rear differential 22 from which power is transmitted to the rear wheels 12 through left and right rear axle shafts 24, 26. The front wheels 10 are driveably connected to right and left axle shafts 32, 34 to which power is transmitted from the front drive shaft 20 through a front differential 36.

A drive train D is defined in general as the mechanical structures including the engine M and transmission 14 output powering the front and rear drive shafts 20, 18 in any suitable arrangement by which the front and rear wheels 10, 12 are concurrently rotated. The drive train D may be broken down into a front drive train F substantially corresponding to the mechanical structures which provide power to the front wheels, and a rear drive train R which substantially corresponds to the respective mechanical structures providing drive power to the rear wheels. As is well known in the art some structures of the drive train D may in some instances be shared by both the front and rear drive trains.

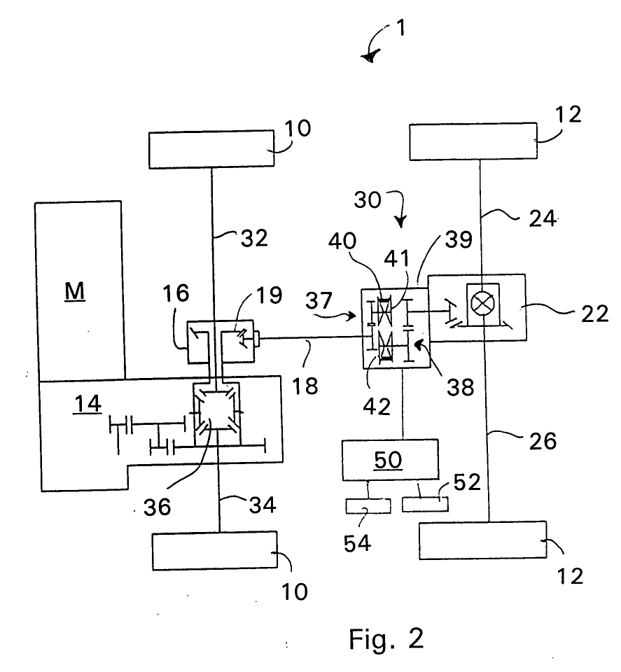

Turning now to FIG. 2, a first embodiment of the present invention is shown. For developing the necessary torque to drive the vehicle, an automatic, manual or a continuously variable transmission (CVT) 14 is shown connected to an engine M for producing a plurality of forward and reverse speed ratios as desired by an operator of the vehicle 1. In the present embodiment of a four wheel or all-wheel-drive (AWD) system, the transmission continuously driveably provides the transmission output to the right and left front axles 32, 34 through the front differential 36. For purposes of the following discussion, the front axles 32, 34 and front differential 36, as well as the rear axles 26, 24 and rear differential 22 can also be referred to respectively as the front and rear axles. The front wheels 10 are driveably connected to the respective right and left axle shafts 32, 34 to which power is transmitted from the transmission output through the front differential 36 to permit the wheels 10 to rotate at different speeds, for example in cornering situations.

In the present AWD system, the transmission output shaft also transmits power to the rear wheels 12 through the transfer case 16. A bevel gear set 19 may be provided in the transfer case 16 either adjacent or integrated with the transmission 14, to send the drive power along the rear drive shaft 18 to the rear differential 22 which, in turn, transfers the power to the rear wheels 12 via left and right rear axle shafts 24, 26.

As discussed in the background of the invention, in known AWD systems the power transfer from the transfer case 16 to the rear differential 22 is not contiguous. A friction clutch or other indirect coupling is provided at some point in the drive train D to interrupt the flow of power along the drive train D. This coupling allows slip, or unlocks a connection between the front and rear drive shafts 20, 18 so that a speed difference between the front and rear wheels 10, 12 can be accounted for. By way of example, typical couplings are straight clutch or a lock-up clutch situated in the rear output shaft 18. As such couplings are well known in the art, no further discussion is provided.

Observing FIG. 2, a continuously variable coupling (CVC) is shown as a variator 30 in the present embodiment situated between the rear drive shaft 18 and the rear differential 22 to account for the speed differential between the front and rear wheels 10, 12. Inside of a rear CVC casing 39, the variator 30 may be incorporated with, or located adjacent the rear differential 22. Also inside the rear CVC casing 39 the variator 30 comprises a first cone pulley pair 41 and a second cone pulley pair 42 physically connected by a drive belt or chain 40. The first cone pulley pair 41 is drivingly connected to the rear drive shaft 18 which provides the input to the CVC to drive the first cone pulley pair 41. According to a specified ratio between the first and second cone pulley pairs 41, 42, to be discussed in further detail below, the second cone pulley 42 is drivingly connected through to the rear differential 22 to finally provide power to the rear wheels 12.

The first cone pulley pair 41 comprises opposing cones having the belt or chain 40 sandwiched therebetween. The second cone pulley pair 42 also comprises opposing cones between which the belt or chain 40 passes. As is well known in the art, the distance from the center of each pulley 41, 42 that the belt or chain 40 contacts the opposing cones is determined by the distance between the opposing cones. Because the first and second cone pulley pairs 41, 42 are spaced a fixed distance from one another, where the belt or chain 40 has a larger radius about the first cone pulley 41, the corresponding radii of the belt or chain 40 about the second cone pulley 42 must be reciprocally smaller. Thus, at a ratio of 1.0 the belt or chain 40 is at the same radii about both the first and second cone pulleys 41, 42.

In large variators such as those used as main vehicle transmissions, ratios may be in the range of around 2.1 to 12.7. It is important that in the present AWD system a ratio span from around 1.0 to about 1.5 is all that is necessary to account for speed differences between the front and rear wheels 10, 12 of the vehicle, although ratio spans from around 0.9 to 1.8, or even about 0.7 at a minimum, to a maximum of about 2.0 are also conceivable dependent upon tire size, vehicle application etc. This ratio span enables a relatively small variator, as compared to a main transmission variator of a CVT, to be used which can be easily positioned adjacent the rear differential 22, or almost anywhere along the drive train D.

It is to be noted that other CVT type devices may also be utilized for the CVC in place of the above described variable diameter pulleys, for example, a toroidal type CVT or a ratio disc type CVT. Using the CVC in the rear drive train permits a direct, or contiguous, fully engaged connection without slip to be maintained between the front and rear wheel drives of the vehicle in all driving conditions, in other words, there is 100% lock-up, no slip losses between the front and rear wheel drive. This elimination of slip facilitates a reduction in energy losses in the drive train while continuing to permit variance in the speed between the front and rear wheels 10, 12.

As shown in FIG. 2, the CVC is positioned in the rear drive train R adjacent the rear differential 22. Based on the relatively small size of the CVC, the variator 30 could be incorporated into the rear differential housing, or as is readily apparent to those of skilled in the art, the CVC could be located in other portions of the drive train D, even in conjunction with the transfer case 16. Additionally, any necessary torque increase or decrease necessary into the CVC can be accomplished by an input planetary or helical gear set 37, and any necessary increase/decrease in torque out of the CVC can similarly be accomplished by an output planetary or helical gear set 38.

The CVC can be either electronically or mechanically operated. To determined the variator ratio, a CVC operating system 50 could utilize certain available measured variables for example wheel speed and steering wheel angle provided from wheel speed sensors 52 and steering wheel angle sensors 54.

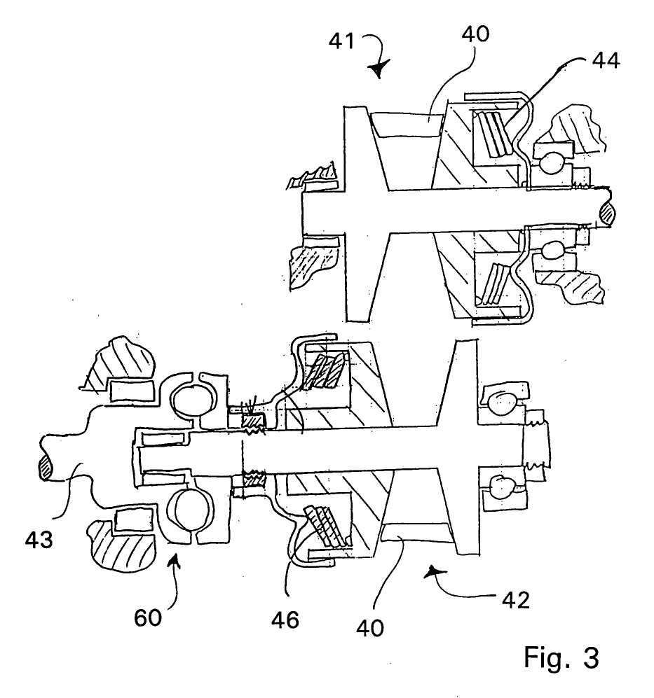

Observing FIG. 3, a mechanical control for the variator ratio may be a cam device, shown here as a ramp and bearing cam 60, situated between the second cone pulley pair 42 and a variator output shaft 43. In this embodiment, the first and second cone pulley pair 41, 42 are each provided with respective preloaded springs 44, 46 to provide a minimum clamping force. By way of example, a change of speed of the variator output shaft 43 relative to the second cone pulley 42 output due to the speed difference between the front and rear wheel sets 10, 12, for instance during cornering by the vehicle, will cause the bearings to ride the associated ramp and vary the distance between the second cone pulley pair 42 thus changing the radius of the belt or chain 40 about the second cone pulley pair 42. A corresponding change in the radius of the belt or chain 40 about the first cone pulley pair 41 changes the variator ratio within a range of about 1.0 to 1.5 to account for the wheel speed difference.

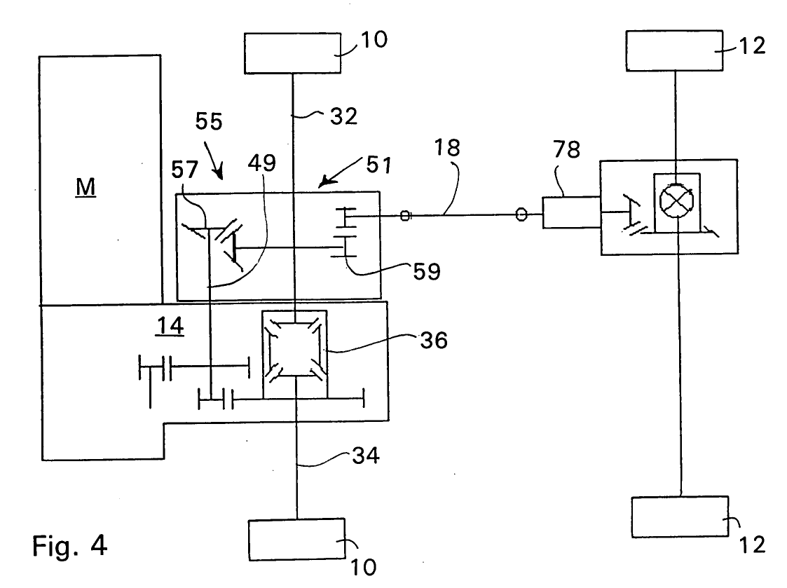

Turning now to FIG. 4, in a further embodiment of the present invention, a transmission 14 provides a direct front wheel output to the left and right front axles 34, 32 via the front differential 36. Separate from the front wheel transaxle, i.e., the front differential 36 and left and right front axles 34, 32, a side shaft 49 extends from the transmission 14 to directly drive the rear wheel set 12. The side shaft 49 forms a power take off unit (PTU) 51 to directly drive the rear drive shaft 18 through a gear set 55, shown here as a set of bevel gears 57 and helical gears 59.

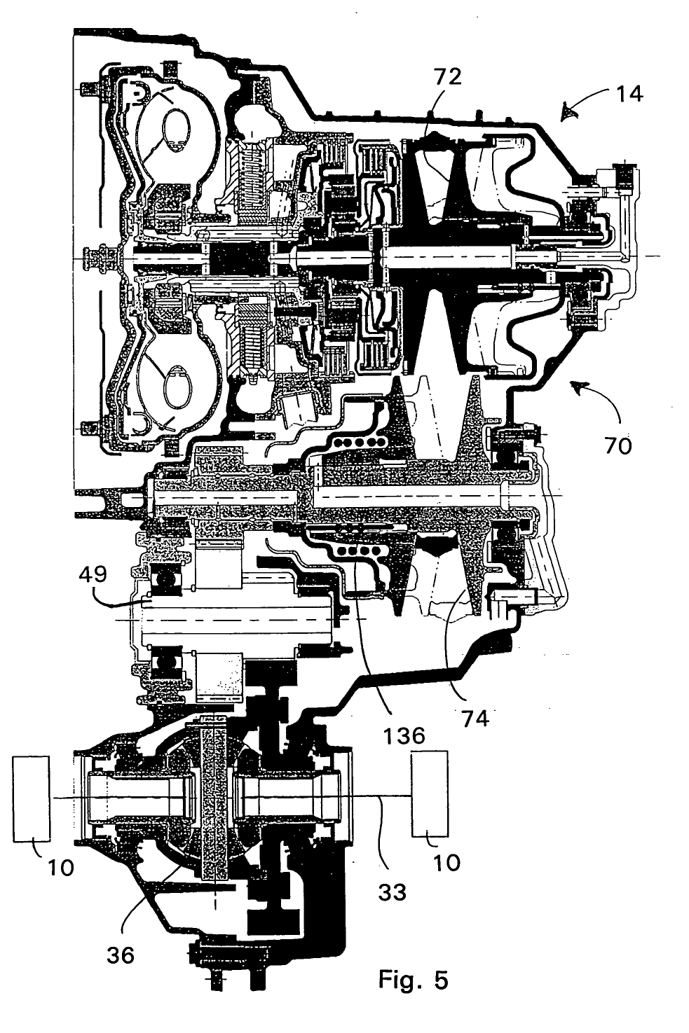

FIG. 5, is an embodiment of the present invention, a CVT transmission variator 70, having a first and a second pair of cone pulleys 72, 74 provided to ensure an appropriate ratio is maintained between the engine or prime mover M and the drive wheels. The design of such a side shaft 49 to directly drive the rear drive shaft 18 via a PTU 51 has distinct advantages made feasible by the side shaft 49 extending from the variator casing to directly power the rear drive. Thus, the CVT provides an integral side shaft 49 to directly transfer power to the rear axle.

As can be seen in the figure, the side shaft 49 provides power to the PTU independent of and before the transfer of power to the front transaxle 33 and the front wheels 10. Using the side shaft 49 provides a more efficient power path to the rear wheels 12 by reducing the number of gears in the power transfer path. Additionally, the torque along the side shaft 49 is about ⅓ of the torque generated at the front differential 36 and thus the bearings and gears for transferring power along the side shaft 49 to the rear drive axle can be substantially reduced in size, as well as allowing more efficient interface and reducing the runout between parts of the transmission 14 and transfer case 16.

Different from known transmission systems, in the present invention the side shaft 49 directly powers the rear drive train via the rear PTU 51 bypassing the front drive train. Such an arrangement of front and rear drive trains is important in that, for example, in a vehicle start up situation where the vehicle is stopped, a high engine speed must be reduced to a low transaxle rotation speed, but high torque through the front and rear axles is necessary to overcome inertia of the vehicle and start the vehicle moving without wheel slip.

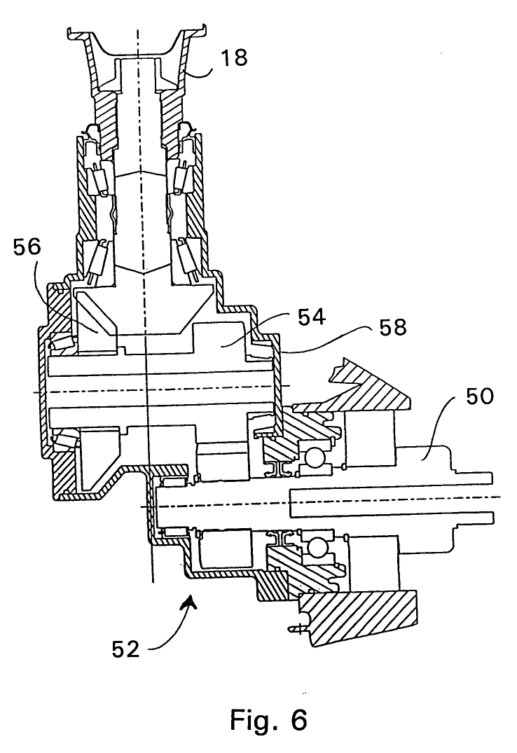

However, for transferring power to the rear wheels 12, it is beneficial to have a high rear drive shaft speed, with low torque and then reduce the speed and raise the torque through the rear differential 22. As seen in FIG. 6, with the side shaft 49 of the present invention forming the rear drive PTU 51, the high speed of the engine is more directly applied to the rear drive shaft 18 without having to account for the substantial torque developed from the front drive train F. Again, with lower torque in the rear drive PTU 51, transfer gears 56, 57 and set may be substantially smaller than previously known for more efficient power transfer from the side shaft 49 to the rear drive 52. The side shaft 49 is provided with a portion extending into a modified transfer case 58 which includes the transfer gears shown as a pair of beveled gears 56 for providing a 90 degree transfer of power from the side shaft 49 to the longitudinally extending rear drive shaft 18.

A coupling 78, shown in FIG. 4, is situated with the rear drive axle 18 to account for the difference in wheel speed between the front and rear wheel sets 10, 12 as is generally necessary in 4-wheel and all-wheel drive vehicles, and to provide the appropriate speed/torque reduction between the rear drive shaft 18 and the rear axles. It is to be noted that the direct rear drive power transmission discussed above including the side shaft 49 and PTU 51 could be used in conjunction with the previously discussed CVC 30 as the coupling 78.

Thus, in a still further embodiment, a direct coupling of the rear wheel drive from the side shaft 49 of the CVT transmission 14 through the PTU 51 would directly transfer power uninterrupted by the speed reduction and torque increase of the front drive train, to the rear wheel axle via the CVC 30 as the coupling 78. This eliminates the torque and speed increase/decrease steps necessary between the front transaxle and the rear axles to provide for a more efficient flow of power to the rear wheels 12 from the engine M. Furthermore, the elimination of a clutch type slip coupling is provided by the use of the CVC to ensure a contiguous power transfer and that no energy is lost in the power transfer along the rear drive shaft 18.

Since certain changes may be made in the above described improved four wheel drive system without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A drive train for a four wheel drive vehicle comprising:
a prime mover powering a transmission providing drive power to a front drive train and rear drive train;
the front drive train having a front transaxle driveably connected to the transmission, the front transaxle having a first differential device located between at least a first and a second front wheels;
the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels; and
a continuously variable coupling situated in the drive train to provide contiguous power transmission between the front drive train and the rear drive train at a desired ratio permitting a difference between a front wheel rotation speed and a rear wheel rotation speed.

2. The drive train for a four wheel drive vehicle as set forth in claim 1, further comprising the continuously variable coupling positioned in the rear drive train to permit the difference between the front wheel rotation speed and the rear wheel rotation speed.

3. The drive train for a four wheel drive vehicle as set forth in claim 2, wherein the continuously variable coupling comprises a variator having a first cone pulley pair and a second cone pulley pair connected by a belt or chain providing a variator ratio between the first and second cone pulley pair in a range of about 0.9-1.8.

4. The drive train for a four wheel drive vehicle as set forth in claim 3, wherein the first cone pulley pair is connected to the rear drive shaft and the second cone pulley pair is connected to the rear axle.

5. The drive train for a four wheel drive vehicle as set forth in claim 4, further comprising a first gear set connecting the rear drive shaft and the first cone pulley pair, and a second gear set connecting the second cone pulley to the rear axle to provide torque control through the variator.

6. A drive train for a four wheel drive vehicle comprising:
a prime mover powering a continuously variable transmission providing drive power to a front drive train and rear drive train;
the front drive train having a front transaxle driveably connected to the transmission, the front transaxle having a first differential device located between at least a first and a second front wheels;
the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels; and
a side shaft separate from the front drive train extending from the continuously variable transmission to provide a power take off for the rear drive shaft independent of any torque change through the front drive train.

7. A drive train for a four wheel drive vehicle comprising:
a prime mover powering a continuously variable transmission providing drive power to a front drive train and rear drive train;
the front drive train having a front transaxle driveably connected to the transmission, the front transaxle having a first differential device located between at least a first and a second front wheels;
the rear drive train having a rear axle driveably connected to the transmission, the rear axle having a second differential device positioned between at least a first and a second rear wheels, and a rear drive shaft extending between the transmission and the rear axle to provide power from the prime mover to the first and second rear wheels;
a side shaft separate from the front drive train extending from the continuously variable transmission to provide a power take off for the rear drive shaft independent of any torque change through the front drive train; and
a continuously variable coupling situated in the drive train to provide contiguous power transmission between the front drive train and the rear drive train at a desired ratio permitting a difference between a front wheel rotation speed and a rear wheel rotation speed.
